(19) United States
(12) Patent Application Publication
(10) Pub. No.: US 2017/0132697 A1
(43) Pub. Date: May 11, 2017

(54) IT EQUIPMENT RENTAL METHOD AND SYSTEM

(71) Applicant: GLOBAL MICRO SOLUTIONS (PTY) LTD, Rosebank (ZA)

(72) Inventor: Jon Jason Rey Milner, Rosebank (ZA)

(73) Assignee: GLOBAL MICRO SOLUTIONS (PTY) LTD, Rosebank (ZA)

(21) Appl. No.: 15/350,881

(22) Filed: Nov. 14, 2016

(30) Foreign Application Priority Data
Nov. 11, 2015 (ZA) 2015/08335

(51) Int. Cl. G06Q 30/06; G06Q 20/04

(52) U.S. Cl. CPC G06Q 30/0645; G06Q 30/0611; G06Q 30/0633; G06Q 20/045

(57) ABSTRACT

According to a first aspect of the invention there is provided an IT equipment rental method, for a customer in respect of whom an IT service provider is already providing a service at a monthly cost in terms of an existing managed care (support) arrangement. The method may comprise receiving a request from the customer to upgrade his/her IT equipment and/or acquire a new item of IT equipment; receiving an indication of the IT equipment desired by the customer; obtaining quotes from providers of the IT equipment desired by the customer, and providing these quotes to the customer, with the provider being a wholesale provider and with the quotes being provided to the customer with no mark up; and prompting the customer to order the desired IT equipment from one of the providers.

### CROSS-REFERENCE TO RELATED APPLICATIONS

This Application claims priority from South African Patent Application No. 2015/08335, filed Nov. 11, 2015, the disclosure of which is incorporated herein by reference in its entirety.

### TECHNICAL FIELD

This invention relates to an IT equipment rental method and related system, including, but not limited to laptops, PCs, Point of Sale (POS) computing devices and hospitality kiosks. The invention covers both the upgrading of an existing machine and/or the acquisition of a new machine. In one version, the method utilizes vouchers having predetermined values.

### BACKGROUND

In general, the rental of IT equipment works well, especially for more expensive IT equipment that may be financially difficult to purchase upfront. However, the problems with traditional IT rental arrangements are as follows:
Complexity: There are typically multiple vendors, finance houses and service providers, which results in multiple contracts, complex fulfilment process, which all results in traditional IT rental arrangements not being suitable for continuous procurement.
Cost: Every role player in the process, namely the finance house takes a margin, the equipment provider and the service provider takes a margin, which results in a relatively expensive business model.
Restrictions: There are typically very limiting restrictions on the equipment that can be rented, resulting in a frustrating contractual process involving negotiating with the equipment provider, then negotiating with the finance provider, providing guarantees to the equipment provider, and only then ordering equipment from the equipment provider.

The end result of traditional IT rental arrangements is higher costs, lower flexibility, and a complicated and time consuming process. The aim of the present invention is to address these shortcomings, with the underlying principle being that newer equipment reduces a provider's cost of doing business.

### BRIEF SUMMARY

According to a first aspect of the invention there is provided an IT equipment rental method, for a customer in respect of whom an IT service provider is already providing a service at a monthly cost in terms of an existing managed care (support) arrangement, the method comprising: (1) receiving a request from the customer to upgrade his/her IT equipment and/or acquire a new item of IT equipment; (2) receiving an indication of the IT equipment desired by the customer; (3) obtaining quotes from providers of the IT equipment desired by the customer, and providing these quotes to the customer, with the provider being a wholesale provider and with the quotes being provided to the customer with no mark up; and (4) prompting the customer to order the desired IT equipment from one of the providers.

In broad terms, a key objective of the present invention is to provide a method of lowering the IT service provider's cost of doing business.

In an embodiment, the method comprises providing the customer with a voucher having a predetermined value, depending upon the IT equipment desired by the customer, to enable the customer to purchase his/her device of choice.

In an embodiment, the voucher, which may be purchased in a conventional manner through any one of a number of channels, is selected from a group of vouchers having a fixed monetary value of, for example, R7,500, R10,000, R12,500, R15,000 or R20,000.

In an embodiment, the method comprises allowing the customer to purchase the IT equipment at the end of the rental period. In one version, the IT equipment may be sold to the customer for a fixed amount corresponding to three rental payments.

According to a second aspect of the invention there is provided an IT equipment rental system, for a customer in respect of whom an IT service provider is already providing a service at a monthly cost in terms of an existing managed care (support) arrangement, the system comprising a processor arranged to: (1) receive a request from the customer to upgrade his/her IT equipment and/or acquire a new item of IT equipment; (2) receive an indication of the IT equipment desired by the cons; (3) obtain quotes from providers of the IT equipment desired by the customer, and providing these quotes to the customer, with the provider being a wholesale provider and with the quotes being provided to the customer with no mark up; and (4) prompt the customer to order the desired IT equipment from one of the providers.

In broad terms, a key objective of the present invention is to provide a system to lower the IT service provider's cost of doing business.

In an embodiment, the processor is arranged to provide the customer with a voucher having a predetermined value, depending upon the IT equipment desired by the customer, to enable the customer to purchase his/her device of choice.

In an embodiment, the voucher, which may be purchased in a conventional manner through any one of a number of channels, is selected from a group of vouchers having a fixed monetary value of, for example, R7,500, R10,000, R12,500, R15,000 or R20,000.

In an embodiment, the processor is arranged to allow the customer to purchase the IT equipment at the end of the rental period. In one version, the IT equipment may be sold to the customer for a fixed amount corresponding to three rental payments.

### BRIEF DESCRIPTION OF THE DRAWINGS

FIG. 1 shows a high level schematic flow diagram representing an IT equipment rental method according to the invention; and

FIG. 2 shows a highly schematic view of an IT equipment rental system, according to an embodiment of the invention.

### DETAILED DESCRIPTION

Referring to the figures, an IT equipment rental method 10 and related system 20 are provided, for a customer or client 22 in respect of whom an IT service provider is already providing a support service at a monthly cost in terms of an existing managed care arrangement. One of the core objectives of the present invention is to provide a method of lowering the IT service provider's cost of doing business.

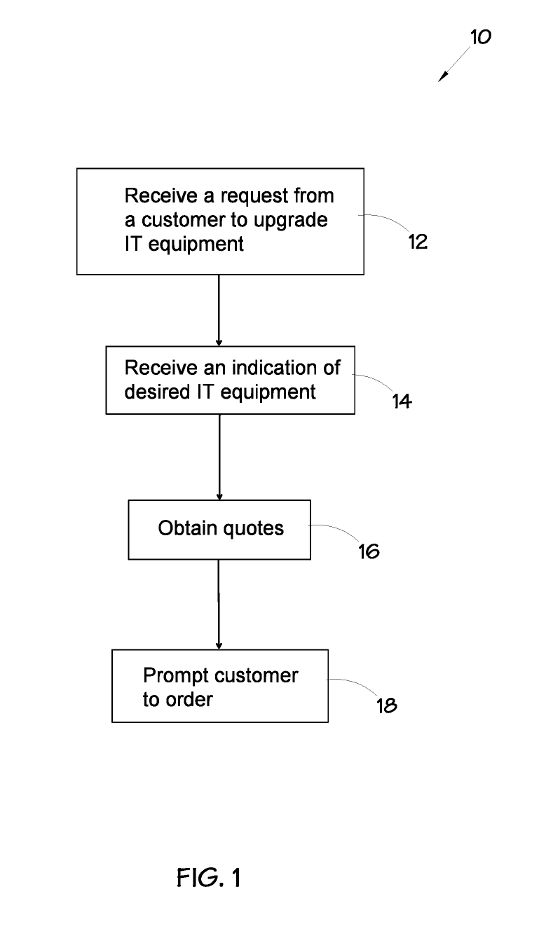

The method 10 comprises receiving a request from the customer to upgrade his/her IT equipment and/or acquire a new item of IT equipment, as indicated by block 12 in FIG. 1. The method 10 then includes receiving an indication of the IT equipment desired by the customer 22, as indicated by block 14 in FIG. 1.

In one version, although not limited thereto, the method 10 then includes providing the customer 22 with a voucher having a predetermined value, depending upon the IT equipment desired by the customer 22, to enable the customer to purchase his/her device of choice. In an embodiment, the voucher is selected from a group of vouchers having a fixed monetary value, for example of, for example, R7,500, R10,000, R12,500, R15,000 or R20,000.

Quotes are then obtained from providers or suppliers 32 of the IT equipment desired by the customer 22, as indicated by block 16 in FIG. 1, which are then provided to the customer 22. In a preferred version, the provider 32 is a wholesale provider, with the quotes accordingly being provided at cost.

Advantageously, the IT service provider running the method 10 and system 20 of present invention would not charge a margin on the cost price. This in turn has a number of advantages, including enabling the customer 22 to use the savings to acquire better equipment, extended warranties or software, and the reduced costs ensures that insurance on the IT equipment is as low as possible. Regarding the latter, the customer is provided copies of all the invoice/s from the provider.

The method 10 concludes by prompting the customer to order the desired IT equipment from a provider as indicated by block 16 in FIG. 1

In an embodiment, the method 10 and system 20 comprises allowing the customer to purchase the IT equipment at the end of the rental period. In one version, the IT equipment may be sold to the customer for a fixed amount corresponding to three rental payments.

A number of examples will now be provided, in respect of a customer who is already paying for a managed care support service from the IT service provider at a cost of R300 per month (on a standard managed care pack).

### EXAMPLE 1

If a customer's laptop needs to be replaced, with the retail cost of a replacement laptop being around R8,200, the following happens:
The customer upgrades his/her subscription from the standard managed care pack to a managed care +rental tier 1 level, on a 3-year subscription.
The laptop is sourced at a wholesale price of around R7,500, with the customer accordingly being provided with a R7,500 voucher which may be used to pay for the desired laptop.
The customer's monthly fee increases from R300 to R475, and so the additional spend over the 3 year period is R175×36 months=R6,300.

The customer thus pays R1,200 less than the wholesale cost price of the laptop and R1 900 less than the price the customer would have paid had s/he purchased the laptop through a dealer (who would typically mark up the laptop by between 10-15%). In addition, the customer has saved all financing costs (which at 12% would have cost you an additional R1,500), and so the financing costs have been subsidised by the IT service provider.

Thus, in total, in this example, the customer has been able to save R3 400, with a consequential advantage being a lowering the IT service provider's cost of doing business.

As indicated above, the customer may purchase the laptop at the end of the 3 year period for a payment corresponding to 3 months rental i.e. R475×3=R1,425.

### EXAMPLE 2

In this example, the customer wishes to replace his/her laptop with a MacBook Air (MJVE2), which costs R15,499 at the Apple iStore. In this case, the following happens:
The customer upgrades his/her subscription from the standard managed care pack to a managed care +rental tier 4 level, on a 3-year subscription.
The laptop is sourced from the Apple iStore using a R15,000 voucher, with the balance of R499 being payable by the customer to make up the balance.
The customer's monthly fee increases from R300 to R850, and so the additional spend over the 3 year period is R550×36 months=R19,800.

It is worth noting that the finance costs on R15,000 over 3 years at 12% are approximately R6,100, and so R19,800 less R6,100=R13,700. The customer has thus been able to save you R1 300 and provide a convenient single source rental solution. Clearly, the savings in this example are not as substantial as those in Example 1, primarily because the IT equipment could not be purchased at a wholesale price (but despite this, the customer is still able to save).

As is clear from the above 2 examples, the present invention results in lower costs, greater flexibility and lower risk, with one of the areas of focus being the subsidy of finance costs.

It an embodiment, the customer may be provided with more than one voucher. For example, if a replacement laptop costs R25,000, the customer may combine 2 vouchers, e.g. a R15 000 voucher plus a R10,000 voucher. Alternatively, the user may take a R20,000 voucher and pay in the difference of R5,000.

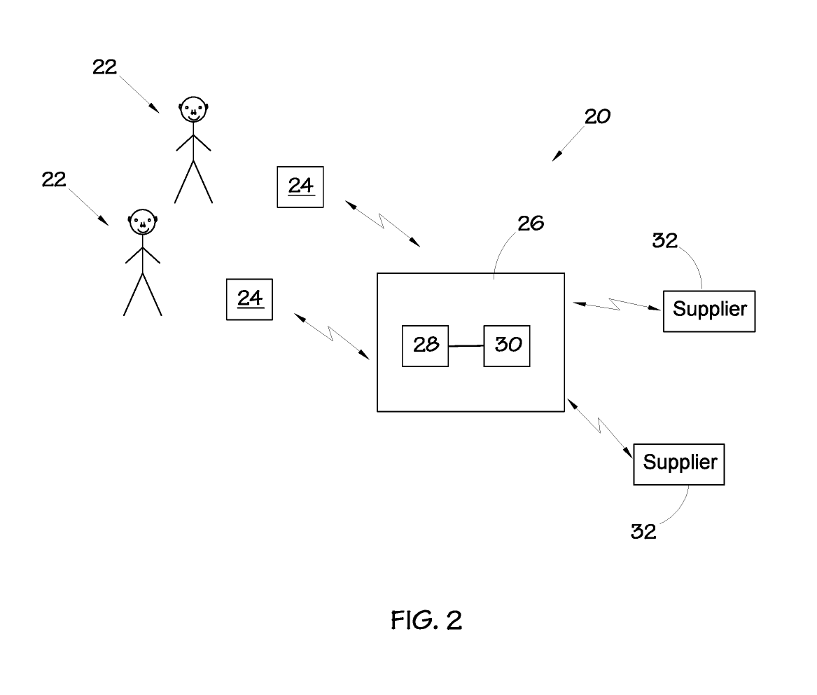

In an embodiment, turning now to FIG. 2, the system 20 may include a central controller arrangement 26 comprising a processor 28, to run the method steps described above, or at least some of the method steps, and a related database 30 to store all relevant information and assist in managing the overall process.

The present invention thus provides a simply, flexible alternative to traditional IT rental arrangements, with associated cost savings. As indicated above, one of the key underlying principles of the invention is that newer equipment reduces the IT service provider's cost of doing business. In particular, basing an IT equipment rental method on the fact that new equipment lowers an IT service provider's cost of doing business, is unique and inventive. The additional key features include the fact that:
there is full price transparency (and that there is no mark up on the IT equipment);
the IT equipment is effectively being provided at below cost (as illustrated in the above examples) and subsidised by the IT service provider;
insurance costs are reduced; and
the customer can own the IT equipment at the end of the rental period.

1. An IT equipment rental method for a customer for whom an IT service provider is already providing a service at a monthly cost in terms of an existing managed care arrangement, the method comprising:
receiving a request from the customer to upgrade his/her IT equipment or acquire a new item of IT equipment;
receiving an indication of the IT equipment desired by the customer;
obtaining quotes from providers of the IT equipment desired by the customer, and providing the quotes to the customer, with the provider being a wholesale provider and with the quotes being provided to the customer with no mark up; and
prompting the customer to order the desired IT equipment from one of the providers.

2. The method of claim 1, which includes providing the customer with a voucher having a predetermined value, depending upon the IT equipment desired by the customer, to enable the customer to purchase his/her device of choice.

3. The method of claim 2, wherein the voucher, which may be purchased in a conventional manner through any one of a number of channels, is selected from a group of vouchers having a fixed monetary value.

4. The method of claim 1, which includes allowing the customer to purchase the IT equipment at the end of the rental period.

5. The method of claim 4, wherein the IT equipment may be sold to the customer for a fixed amount corresponding to three rental payments.

6. An IT equipment rental system for a customer for whom an IT service provider is already providing a service at a monthly cost in terms of an existing managed care arrangement, the system comprising a processor arranged to:
receive a request from the customer to upgrade his/her IT equipment or acquire a new item of IT equipment;
receive an indication of the IT equipment desired by the customer;
obtain quotes from providers of the IT equipment desired by the customer, and provide these quotes to the customer, with the provider being a wholesale provider and with the quotes being provided to the customer with no mark up; and
prompt the customer to order the desired IT equipment from one of the providers.

7. The system of claim 6, wherein the processor is arranged to provide the customer with a voucher having a predetermined value, depending upon the IT equipment desired by the customer, to enable the customer to purchase his/her device of choice.

8. The system of claim 7, wherein the voucher, which may be purchased in a conventional manner through any one of a number of channels, is selected from a group of vouchers having a fixed monetary value.

9. The system of claim 6, wherein the processor is arranged to allow the customer to purchase the IT equipment at the end of the rental period.
